(19) United States
(12) Patent Application Publication
(10) Pub. No.: US 2021/0129184 A1
(43) Pub. Date: May 6, 2021

(54) BRILLIANT PIGMENT-CONTAINING AQUEOUS BASE COAT COATING MATERIAL, AND METHOD FOR FORMING MULTILAYER FILM USING SAME

(71) Applicant: KANSAI PAINT CO., LTD., Hyogo (JP)

(72) Inventors: Hiroki TAKEDA, Aichi (JP); Tohru IWAMOTO, Kanagawa (JP); Hiromi KATOH, Aichi (JP); Junichi KAJIMA, Aichi (JP); Shigeru TOMIZAWA, Kanagawa (JP)

(73) Assignee: KANSAI PAINT CO., LTD., Hyogo (JP)

(21) Appl. No.: 17/147,104

(22) Filed: Jan. 12, 2021

Related U.S. Application Data
(62) Division of application No. 16/074,694, filed on Aug. 1, 2018.

(30) Foreign Application Priority Data
Feb. 2, 2016 (JP) 2016-018095

(51) Int. Cl. B05D 7/00; C09D 133/26; C09D 133/00; C09D 5/02; C09D 133/02; C09D 7/61; C09D 7/40; B05D 5/06; B05D 7/14; B05D 7/02

(52) U.S. Cl. CPC B05D 7/532; C09D 133/26; C09D 133/00; C09D 5/028; C09D 133/02; C08K 3/08; C09D 7/70; B05D 5/06; B05D 7/14; B05D 7/02; B05D 2202/10; C09D 7/61

(57) ABSTRACT

Provided are a brilliant pigment-containing aqueous base coat coating material with which it is possible to ensure waterproof adhesiveness and impart a metallic gloss, and a method for forming a multilayer film using the same. The invention provides a brilliant pigment-containing aqueous base coat coating material including water-dispersible acrylic polymer particles (A), a water-soluble acrylic resin (B), a curing agent (C), and a brilliant pigment (D) obtained by pulverizing a vapor-deposited metal film to create metal chips. The water-soluble acrylic resin (B) is a copolymer of an N-substituted (meth)acrylamide (i), a hydroxyl group-containing polymerizable unsaturated monomer (ii), a carboxyl group-containing polymerizable unsaturated monomer (iii), and a polymerizable unsaturated monomer (iv) other than (i)-(iii). The brilliant pigment (D) is contained in a pigment weight concentration (PWC) in the range

### FIELD

The present invention relates to a brilliant pigment-containing aqueous base coat coating material that can ensure waterproof adhesiveness and impart a metallic gloss, as well as to a method for forming a multilayer film using it.

### BACKGROUND

Coating of automobile bodies is generally carried out by first applying an electrodeposition coating as a primer coating, and then applying an intercoat material, and a top coat material over it.

Examples of coating methods for top coat materials include a 1-coat, 1-bake method in which one type of top coat material is applied and heat cured, and a 2-coat, 1-bake method in which two types of top coat materials, a base coat material and a clear coating material, are used, applying the base coat material first and, without curing it, applying the clear coating material over it and then simultaneously heat curing both coating films.

Of these prior art methods, in application by a 2-coat, 1-bake method a sheen quality is commonly imparted by using a base coat material containing a brilliant pigment such as aluminum flakes or mica as the base coat material, to improve the outer appearance of the coating film.

On the other hand, water solubilization of coating materials has advanced in recent years from the viewpoint of reducing air pollution and conserving resources, and therefore active efforts are currently being made to develop brilliant pigment-containing aqueous base coat coating materials that can form coating films with excellent sheen quality.

One of the means for improving the sheen quality of base coating films formed from brilliant pigment-containing aqueous base coat coating materials has been a method of increasing the pigment weight concentration (hereunder also abbreviated as “PWC”) of brilliant pigments with respect to the solid content of coating materials. However, if the PWC of the brilliant pigment in the aqueous base coat coating material is high, then problems may result such as reduced luster and smoothness of the coating film formed from it, inability to obtain an adequate finished appearance, and reduced film performance such as water resistance.

As a countermeasure, PTL 1, for example, discloses a coating method in which an aqueous base coat coating material having a relatively high brilliant pigment PWC and a relatively low solid content of the coating material is recoated over a coating film formed by an aqueous base coat coating material with a relatively low brilliant pigment PWC and a relatively high solid content of the coating material, and is further recoated with a clear coating material, to form a coating film with a sheen quality having an excellent outer appearance. In this coating method, however, the sheen quality and smoothness of the coating film that is to be obtained have been insufficient.

Methods of using vapor deposited aluminum fragments as brilliant pigments in order to obtain a metallic glossy feel are known, and for example, PTL 2 discloses an aqueous base coating material composition comprising a brilliant pigment consisting of metal fragments obtained by pulverizing a vapor deposited metal film, and an aqueous cellulose derivative having an acid value of 20 to 150 mgKOH/g (solid content), the aqueous cellulose derivative being used as the main binder resin, and the brilliant pigment content being 20 to 70 mass % as the PWC. However, waterproof adhesiveness has been a problem associated with coating films formed using the coating material described in PTL 2.

### CITATION LIST

### Patent Literature

[PTL 1] Japanese Unexamined Patent Publication No. 2004-351389

[PTL 2] Japanese Unexamined Patent Publication No. 2009-155537

### SUMMARY

### Technical Problem

It is an object of the present invention to provide a brilliant pigment-containing aqueous base coat coating material that can form a coating film that ensures waterproof adhesiveness and has an excellent metallic gloss feel.

### Solution to Problem

As a result of much diligent research, the present inventors have found that the aforementioned object can be achieved by a brilliant pigment-containing aqueous base coat coating material comprising water-dispersible acrylic polymer particles (A), a specific water-soluble acrylic resin (B), a curing agent (C) and a brilliant pigment (D) consisting of metal fragments obtained by pulverizing a vapor deposited metal film, and the invention has been completed upon this finding.

The present invention therefore provides a brilliant pigment-containing aqueous base coat coating material comprising water-dispersible acrylic polymer particles (A), a water-soluble acrylic resin (B), a curing agent (C) and a brilliant pigment (D) consisting of metal fragments obtained by pulverizing a vapor deposited metal film, wherein the water-soluble acrylic resin (B) is a copolymer of (i) N-substituted (meth)acrylamide, (ii) a hydroxyl-containing polymerizable unsaturated monomer, (iii) a carboxyl group-containing polymerizable unsaturated monomer and (iv) another polymerizable unsaturated monomer other than (i) to (iii), and the brilliant pigment (D) is contained at a pigment weight concentration (PWC) in the range of 10 to 40%, as well as a method for forming a multilayer film using the same.

### Advantageous Effects of Invention

With the brilliant pigment-containing aqueous base coat coating material of the invention it is possible to form a coating film that ensures waterproof adhesiveness and has an excellent metallic gloss feel.

### DESCRIPTION OF EMBODIMENTS

The brilliant pigment-containing aqueous base coat coating material of the invention will now be described in greater detail.

The brilliant pigment-containing aqueous base coat coating material of the invention (hereunder also referred to as “the present coating material”) is a coating material containing water-dispersible acrylic polymer particles (A), a water-soluble acrylic resin (B) and a curing agent (C), and further containing a brilliant pigment (D) at a pigment weight concentration (PWC) in the range of 10 to 40%.

Throughout the present specification, the pigment weight concentration (PWC) of the brilliant pigment (D) is the mass ratio of the brilliant pigment (D) with respect to the solid content of the coating material.

### Water-Dispersible Acrylic Polymer Particles (A):

The water-dispersible acrylic polymer particles (A) to be used for the present coating material compose at least part of the base resin of the present coating material, and they are usually obtained by emulsion polymerization of a polymerizable unsaturated monomer using a radical polymerization initiator in the presence of a dispersion stabilizer such as a surfactant. As such water-dispersible acrylic polymer particles (A) it is particularly preferred to use water-dispersible acrylic polymer particles obtained by emulsion polymerization of a polymerizable unsaturated monomer mixture containing a polymerizable unsaturated monomer (M-1) having two or more polymerizable unsaturated groups in the molecule, the water-dispersible acrylic polymer particles being obtained by emulsion polymerization of a polymerizable unsaturated monomer (M-1) having two or more polymerizable unsaturated groups in the molecule together with one or more other polymerizable unsaturated monomers (M-2).

The polymerizable unsaturated monomer (M-1) having two or more polymerizable unsaturated groups in the molecule may be an amide group-containing polymerizable unsaturated monomer (M-1-1) having two or more polymerizable unsaturated groups in the molecule, or another polymerizable unsaturated monomer (M-1-2) having two or more polymerizable unsaturated groups in the molecule. Particularly preferred for use is an amide group-containing polymerizable unsaturated monomer (M-1-1) having two or more polymerizable unsaturated groups in the molecule.

Specific examples for the amide group-containing polymerizable unsaturated monomer (M-1-1) having two or more polymerizable unsaturated groups in the molecule include C1-6 alkylenebis(meth)acrylamides such as N,N′-methylenebis(meth)acrylamide, N,N′-ethylenebis(meth)acrylamide and N,N′-tetramethylenebis(meth)acrylamide; N,N′-1,3-phenylenebisacrylamide; and N,N′-(oxymethylene)bisacrylamide. Examples of polymerizable unsaturated monomers (M-1-2) having two or more polymerizable unsaturated groups in the molecule other than the monomer (M-1-1) include allyl (meth)acrylate and 1,6-hexanediol di(meth)acrylate.

The other polymerizable unsaturated monomer (M-2) is not particularly restricted so long as it can copolymerize with the amide group-containing polymerizable unsaturated monomer (M-1), and examples include carboxyl group-containing polymerizable unsaturated monomers (M-2-1), hydroxyl-containing polymerizable unsaturated monomers (M-2-2), and other polymerizable unsaturated monomers (M-2-3).

Examples of carboxyl group-containing polymerizable unsaturated monomers (M-2-1) include unsaturated monocarboxylic acids such as (meth)acrylic acid and crotonic acid; unsaturated dicarboxylic acids such as maleic acid, fumaric acid and itaconic acid, and half monoalkyl esters of these unsaturated dicarboxylic acids, any of which may be used alone or in combinations of two or more. Of these, (meth)acrylic acid is preferred from the viewpoint of exhibiting coating material viscosity, and film performance.

Examples of hydroxyl-containing polymerizable unsaturated monomers (M-2-2) include C2-10 hydroxyalkyl esters of (meth)acrylic acid, such as 2-hydroxyethyl (meth)acrylate, 2- or 3-hydroxypropyl (meth)acrylate and 4-hydroxybutyl (meth)acrylate. The hydroxyl group in the hydroxyl-containing polymerizable unsaturated monomer (M-2-2) can act as a functional group that reacts with the curing agent (C). These hydroxyl-containing polymerizable unsaturated monomers (M-2-2) may be used alone or in combinations of two or more.

Other polymerizable unsaturated monomers (M-2-3) other than the polymerizable unsaturated monomers (M-2-1) and (M-2-2) may also be used, examples of such polymerizable unsaturated monomers (M-2-3) including C1-20 alkyl esters of (meth)acrylic acid such as methyl (meth)acrylate, ethyl (meth)acrylate, n-propyl (meth)acrylate, i-propyl (meth)acrylate, n-butyl (meth)acrylate, i-butyl (meth)acrylate, t-butyl (meth)acrylate, 2-ethylhexyl (meth)acrylate, cyclohexyl (meth)acrylate and lauryl (meth)acrylate; aromatic vinyl compounds such as styrene, α-methylstyrene and vinyltoluene; glycidyl group-containing vinyl compounds such as glycidyl (meth)acrylate and allyl glycidyl ether; nitrogen-containing alkyl (C1-20) (meth)acrylates such as dimethylaminoethyl (meth)acrylate; vinyl compounds such as vinyl acetate, vinyl propionate and vinyl chloride; polymerizable unsaturated bond-containing nitrile-based compounds such as acrylonitrile and methyacrylonitrile; and diene-based compounds such as butadiene and isoprene.

The other polymerizable unsaturated monomer (M-2) used may be any of the polymerizable unsaturated monomers (M-2-1) to (M-2-3) mentioned above, either alone or in combinations of two or more.

The water-dispersible acrylic polymer particles (A) are most preferably obtained by emulsion polymerization of a polymerizable unsaturated monomer mixture containing a polymerizable unsaturated monomer (M-1) having two or more polymerizable unsaturated groups in the molecule, a carboxyl group-containing polymerizable unsaturated monomer (M-2-1) and a hydroxyl-containing polymerizable unsaturated monomer (M-2-2). From the viewpoint of water resistance of the coating film, it is particularly preferred to use methacrylic acid as the carboxyl group-containing polymerizable unsaturated monomer (M-2-1). The reason for this is presumably because methacrylic acid has a low dissociation degree in water compared to acrylic acid, and the carboxyl groups as hydrophilic functional groups become uniformly distributed inside the particles more easily than acrylic acid, such that localization of the hydrophilic functional groups is less likely to occur.

Throughout the present specification, “(meth)acrylate” means “acrylate or methacrylate”, and “(meth)acrylic acid” means “acrylic acid or methacrylic acid”. Also, “(meth)acryloyl” means “acryloyl or methacryloyl”, and “(meth)acrylamide” means “acrylamide or methacrylamide”.

The mixing proportion of the polymerizable unsaturated monomer (M-1) having two or more polymerizable unsaturated groups in the molecule in the polymerizable unsaturated monomer mixture will generally be in the range of 0.1 to 5 mass %, preferably 0.5 to 4 mass % and more preferably 1 to 3.5 mass %, based on the total amount of the polymerizable unsaturated monomer, from the viewpoint of the finished appearance of the coating film and the storage stability of the water-dispersible acrylic polymer particles (A).

Also, from the viewpoint of the outer appearance and water resistance of the coating film, the mixing proportion of the carboxyl group-containing polymerizable unsaturated monomer (M-2-1) in the polymerizable unsaturated monomer mixture may generally be in the range of 0.1 to 20 mass %, preferably 0.5 to 15 mass % and more preferably 1 to 10 mass %, and from the viewpoint of the curability and water resistance of the coating film, the mixing proportion of the hydroxyl-containing polymerizable unsaturated monomer (M-2-2) may generally be in the range of 0.1 to 20 mass %, preferably 1 to 15 mass % and more preferably 2 to 10 mass %. In a polymerizable unsaturated monomer mixture having this mixing proportion, it is particularly preferred to use methacrylic acid as the carboxyl group-containing polymerizable unsaturated monomer (M-2-1).

The water-dispersible acrylic polymer particles (A) can be obtained by emulsion polymerization of a polymerizable unsaturated monomer (M-1) having two or more polymerizable unsaturated groups in the molecule, together with another polymerizable unsaturated monomer (M-2), in the presence of an emulsifying agent and in the co-presence of a radical polymerization initiator.

Examples for the emulsifying agent include anionic emulsifying agents such as sodium dialkylsulfosuccinates, sodium dodecylbenzenesulfonate, sodium lauryl sulfate, sodium polyoxyethylenealkylphenyl ether sulfates and sodium alkyldiphenylether disulfonates; cationic emulsifying agents such as lauryltrimethylammonium chloride, stearyltrimethylammonium chloride and alkylbenzyldimethylammonium chlorides; and nonionic emulsifying agents such as polyoxyethylene higher alcohol ether and polyoxyethylene alkylphenyl ethers, as well as reactive emulsifying agents with polymerizable unsaturated groups.

The emulsifying agent used is preferably a reactive emulsifying agent, with anionic reactive emulsifying agents being particularly preferred for use from the viewpoint of water resistance of the coating film that is to be obtained.

Examples of anionic reactive emulsifying agents include sodium salts and ammonium salts of sulfonic acid compounds having polymerizable unsaturated groups such as (meth)allyl, (meth)acrylic, propenyl and butenyl groups. Of these, ammonium salts of sulfonic acid compounds with polymerizable unsaturated groups are preferred for excellent water resistance of the obtained coating film. An example of a commercial ammonium salt of a sulfonic acid compound is “LATEMUL S-180A” (trade name of Kao Corp.).

More preferred among ammonium salts of sulfonic acid compounds with polymerizable unsaturated groups are ammonium salts of sulfonic acid compounds having polymerizable unsaturated groups and polyoxyalkylene groups. Examples of commercial products that are ammonium salts of sulfonic acid compounds with polymerizable unsaturated groups and polyoxyalkylene groups include AQUALON KH-10 (trade name of Dai-ichi Kogyo Seiyaku Co., Ltd.) and SR-1025A (trade name of Adeka Corp.).

The concentration of the emulsifying agent is usually preferred to be in the range of 0.1 to 10 mass % and especially 1 to 5 mass %, based on the total amount of the radical polymerizable unsaturated monomer that is used.

The water-dispersible acrylic polymer particles (A) preferably have a multilayer structure synthesized by a multistage reaction. Specific examples include particles having a core/shell structure, which is a two-layer structure, or a first core/second core/shell structure, which is a three-layer structure. From the viewpoint of film performance and of productivity for the water-dispersible acrylic polymer particles (A), they preferably have a core/shell structure, as a two-layer structure. From the viewpoint of film performance and of the finished appearance of the coating film, particles wherein the core section is intramolecularly crosslinked and the shell section is essentially uncrosslinked are especially preferred.

Water-dispersible acrylic polymer particles (A) having a core/shell structure wherein the core section is intramolecularly crosslinked can be obtained, for example, by emulsion polymerization of a polymerizable unsaturated monomer mixture (I) containing a polymerizable unsaturated monomer (M-1) having two or more polymerizable unsaturated groups in the molecule, to form the core section, and then adding a polymerizable unsaturated monomer mixture (II) containing a carboxyl group-containing polymerizable unsaturated monomer (M-2-1) and conducting further emulsion polymerization to form the shell section.

The proportion of the carboxyl group-containing polymerizable unsaturated monomer (M-2-1) used in the water-dispersible acrylic polymer particles (A) having a core/shell structure wherein the core section is intramolecularly crosslinked, in the initial core section synthesis, is usually preferred to be in the range of 0 to 10 mass %, especially 0 to 5 mass %, and most especially 0 to 2 mass %, based on the mass of the polymerizable unsaturated monomer mixture (I) used to form the core section, and in the subsequent shell section synthesis, it is usually preferred to be in the range of 5 to 30 mass %, especially 7 to 25 mass % and most especially 10 to 20 mass %, based on the mass of the polymerizable unsaturated monomer mixture used to form the shell section.

Furthermore, when the polymerizable unsaturated monomer mixture contains a polymerizable unsaturated monomer (M-1) having two or more polymerizable unsaturated groups in the molecule, the polymerizable unsaturated monomer mixture (II) preferably contains, in addition to the carboxyl group-containing polymerizable unsaturated monomer (M-2-1), also an aromatic vinyl compound in the range of usually 2 to 30 mass % and especially 5 to 20 mass %, based on the mass of the polymerizable unsaturated monomer mixture (II) used to form the shell section.

Examples of such aromatic vinyl compounds include styrene, α-methylstyrene and vinyltoluene, among which styrene is particularly preferred.

The water-dispersible acrylic polymer particles (A) having a core/shell structure wherein the core section is intramolecularly crosslinked are preferably water-dispersible acrylic polymer particles obtained by emulsion polymerization of a polymerizable unsaturated monomer mixture (I) containing a polymerizable unsaturated monomer (M-1) having two or more polymerizable unsaturated groups in the molecule, in the range of usually 0.1 to 5 mass %, preferably 0.5 to 4 mass % and more preferably 0.75 to 3.5 mass %, based on the mass of the polymerizable unsaturated monomer mixture (I) used to form the core section, and then adding a polymerizable unsaturated monomer mixture (II) for formation of the shell section, containing a carboxyl group-containing polymerizable unsaturated monomer (M-2-1) in the range of usually 3 to 30 mass %, preferably 6 to 25 mass % and more preferably 11 to 20 mass %, based on the mass of the polymerizable unsaturated monomer mixture (II) used to form the shell section, and further containing styrene in the range of usually 2 to 30 mass %, preferably 5 to 20 mass % and more preferably 11 to 20 mass %, and conducting further emulsion polymerization.

When the water-dispersible acrylic polymer particles (A) have a two-layer structure, the mass ratio of the core section/shell section is not strictly limited, but from the viewpoint of the outer appearance and water resistance of the coating film, a suitable range will usually be 95/5 to 50/50, particularly 85/15 to 60/40 and especially 80/20 to 65/35, based on the mass of the total radical polymerizable unsaturated monomers used.

The method of intramolecular crosslinking of the water-dispersible acrylic polymer particles may be a method in which a polymerizable unsaturated monomer (M-2-1) with a carboxyl group and a polymerizable unsaturated monomer with a glycidyl group are each used together in small amounts in addition to the polymerizable unsaturated monomer (M-1) having two or more polymerizable unsaturated groups in the molecule; or a method in which a hydroxyl-containing polymerizable unsaturated monomer (M-2-2) and a polymerizable unsaturated monomer with an isocyanate group are each used together in small amounts.

Examples of polymerization initiators include peroxides, typical of which are ammonium persulfate, potassium persulfate and ammonium peroxide; redox initiators composed of these peroxides in combination with a reducing agent such as sodium hydrogen sulfite, sodium thiosulfate, Rongalite or ascorbic acid; and azo compounds such as 4,4′-azobis(4-cyanobutanoic acid). These polymerization initiators may be used in ranges of generally 0.01 to 10 mass % and preferably 0.1 to 5 mass %, based on the total amount of polymerizable unsaturated monomers used.

The reaction temperature during emulsion polymerization will differ depending on the polymerization initiator used, but it may usually be in the range of about 60° C. to about 90° C., and the reaction time may usually be about 5 to 10 hours.

From the viewpoint of water resistance of the coating film that is to be obtained, the water-dispersible acrylic polymer particles (A) preferably have a hydroxyl value in the range of usually 1 to 70 mgKOH/g, especially 2 to 60 mgKOH/g and more especially 5 to 50 mgKOH/g.

From the viewpoint of storage stability and the water resistance of the coating film that is to be obtained, the water-dispersible acrylic polymer particles (A) preferably have an acid value in the range of usually 5 to 90 mgKOH/g, especially 10 to 70 mgKOH/g and most especially 15 to 50 mgKOH/g.

The water-dispersible acrylic polymer particles (A) may also have a mean particle diameter in the range of usually 10 to 1000 nm, preferably 20 to 500 nm and more preferably 40 to 350 nm. The mean particle diameter of the water-dispersible acrylic resin (A) for the invention is the value measured by the Coulter counter method at a measuring temperature of 20° C. The measurement may be carried out using a “COULTER N4” (trade name of Beckman Coulter, Inc.), for example.

The water-dispersible acrylic polymer particles (A) are preferably neutralized with a basic compound. The basic compound is preferably water-soluble, and as examples there may be mentioned ammonia, or an amine such as methylamine, ethylamine, propylamine, butylamine, dimethylamine, trimethylamine, triethylamine, ethylenediamine, morpholine, methylethanolamine, 2-(dimethylamino)ethanol, diethanolamine, triethanolamine, diisopropanolamine and 2-amino-2-methylpropanol. These may be used alone or in combinations of two or more, and among them, alkanolamines such as 2-(dimethylamino)ethanol, diethanolamine and triethanolamine are preferably used.

The water-dispersible acrylic polymer particles (A) may be used in the range of usually 5 to 70 parts by mass, preferably 5 to 60 parts by mass and more preferably 10 to 50 parts by mass, as the solid content based on 100 parts by mass as the solid resin content of the present coating material.

### Water-Soluble Acrylic Resin (B):

The water-soluble acrylic resin (B) to be used for the present coating material is a component that improves the waterproof adhesiveness of the formed coating film, and it is a copolymer of an N-substituted (meth)acrylamide (i), a hydroxyl-containing polymerizable unsaturated monomer (ii), a carboxyl group-containing polymerizable unsaturated monomer (iii) and an another polymerizable unsaturated monomer other than (i) to (iii) (iv).

Examples for the N-substituted (meth)acrylamide (i) include N-methylacrylamide, N-methylmethacrylamide, N-methylolacrylamide, N-methylolmethacrylamide, N-methoxymethylacrylamide, N-methoxymethylmethacrylamide, N-ethoxymethylacrylamide, N-ethoxymethylmethacrylamide, N-propoxymethylacrylamide, N-propoxymethylmethacrylamide, N-butoxymethylacrylamide, N-butoxymethylmethacrylamide, N-phenoxymethylacrylamide, N-phenoxymethylmethacrylamide, N-ethylacrylamide, N-ethylmethacrylamide, N-n-propylacrylamide, N-n-propylmethacrylamide, N-isopropylacrylamide, N-isopropylmethacrylamide, N-cyclopropylacrylamide and N-cyclopropylmethacrylamide, which may each be used alone or in combinations of two or more.

Of these, from the viewpoint of ensuring waterproof adhesiveness for the formed coating film, it is preferred to use N-methylolacrylamide, N-methylolmethacrylamide, N-methoxymethylacrylamide, N-methoxymethylmethacrylamide, N-ethoxymethylacrylamide, N-ethoxymethylmethacrylamide, N-propoxymethylacrylamide, N-propoxymethylmethacrylamide, N-butoxymethylacrylamide or N-butoxymethylmethacrylamide.

The hydroxyl-containing polymerizable unsaturated monomer (ii) used may be, for example, a monoesterified product of (meth)acrylic acid and a C2-8 dihydric alcohol, such as 2-hydroxyethyl (meth)acrylate, 2-hydroxypropyl (meth)acrylate, 3-hydroxypropyl (meth)acrylate or 4-hydroxybutyl (meth)acrylate; an ε-caprolactone-modified form of any of these monoesterified products of (meth)acrylic acid and C2-8 dihydric alcohols; or an allyl alcohol, any of the above of which may be used alone or in combinations of two or more.

The carboxyl group-containing polymerizable unsaturated monomer (iii) used may be, for example, an unsaturated monocarboxylic acid such as (meth)acrylic acid or crotonic acid; an unsaturated dicarboxylic acid such as maleic acid, fumaric acid or itaconic acid, or a half monoalkyl ester of any of these unsaturated dicarboxylic acids, any of the above of which may be used alone or in combinations of two or more.

The other polymerizable unsaturated monomer (iv) is a polymerizable unsaturated monomer other than (i) to (iii) above, examples of which include C1-20 alkyl esters of (meth)acrylic acid such as methyl (meth)acrylate, ethyl (meth)acrylate, n-propyl (meth)acrylate, i-propyl (meth)acrylate, n-butyl (meth)acrylate, i-butyl (meth)acrylate, t-butyl (meth)acrylate, 2-ethylhexyl (meth)acrylate, cyclohexyl (meth)acrylate and lauryl (meth)acrylate; aromatic vinyl compounds such as styrene, α-methylstyrene and vinyltoluene; glycidyl group-containing vinyl compounds such as glycidyl (meth)acrylate and allyl glycidyl ether; vinyl compounds such as vinyl acetate, vinyl propionate and vinyl chloride; polymerizable unsaturated bond-containing nitrile-based compounds such as acrylonitrile and methyacrylonitrile; and diene-based compounds such as butadiene and isoprene, any of which may be used alone or in combinations of two or more.

Preferably, the water-soluble acrylic resin (B) is a copolymer of 3 to 50 mass % and especially 10 to 40 mass % of an N-substituted (meth)acrylamide (i), 1 to 30 mass % and especially 1 to 25 mass % of a hydroxyl-containing polymerizable unsaturated monomer (ii), 1 to 15 mass % and especially 1 to 12 mass % of a carboxyl group-containing polymerizable unsaturated monomer (iii), and 5 to 95 mass % and especially 23 to 88 mass % of another polymerizable unsaturated monomer (iv), based on the total solid content of monomers used, from the viewpoint of ensuring waterproof adhesiveness of the coating film that is formed.

The method of producing the water-soluble acrylic resin (B) is not particularly restricted, and for example, it may be obtained by copolymerization of the polymerizable unsaturated monomers (i) to (iv) by solution polymerization in an organic solvent in the presence of a polymerization initiator, according to a common method. The organic solvent used for solution polymerization is preferably a propylene glycol-based or dipropylene glycol-based hydrophilic organic solvent, for example.

The acrylic resin (B) preferably has a weight-average molecular weight in the range of 5,000 to 100,000 and especially 10,000 to 70,000. Preferably, the acrylic resin (B) has a hydroxyl value in the range of usually 5 to 150 mgKOH/g and especially 10 to 100 mgKOH/g, and an acid value in the range of usually 10 to 100 mgKOH/g and especially 15 to 60 mgKOH/g.

Throughout the present specification, “number-average molecular weight” and “weight-average molecular weight” are the values determined by converting the retention time (retention volume) using gel permeation chromatography (GPC) to polystyrene molecular weight based on the retention time (retention volume) for standard polystyrene of known molecular weight, measured under the same conditions. Specifically, it may be measured using “HLC8120GPC” (trade name of Tosoh Corp.) as the gel permeation chromatograph, using 4 columns, a “TSKgel G-4000HXL”, “TSKgel G-3000HXL”, “TSKgel G-2500HXL” and “TSKgel G-2000HXL” (all trade names of Tosoh Corp.) as the columns, and using a differential refractometer as the detector, under the conditions of mobile phase: tetrahydrofuran, measuring temperature: 40° C., flow rate: 1 mL/min.

The water-soluble acrylic resin (B) may be used in the range of usually 5 to 50 parts by mass, preferably 5 to 45 parts by mass and more preferably 10 to 40 parts by mass, as the solid content based on 100 parts by mass as the solid resin content of the present coating material.

### Curing Agent (C):

The curing agent (C) may be, for example, an amino resin, polyisocyanate compound, blocked polyisocyanate compound, epoxy group-containing compound, carboxyl group-containing compound, carbodiimide group-containing compound, hydrazide group-containing compound or semicarbazide group-containing compound. Of these, amino resins and blocked polyisocyanate compounds that can react with hydroxyl groups are preferred. The curing agents may be used either alone or in combinations of two or more.

Examples of amino resins include partial or total methylolated amino resins obtained by reacting an aldehyde with an amino component such as melamine, urea, benzoguanamine, acetoguanamine, steroguanamine, spiroguanamine or dicyandiamide. Aldehydes include formaldehyde, paraformaldehyde, acetaldehyde and benzaldehyde. The methylolated amino resin used may be one having the methylol groups partially or totally etherified with an appropriate alcohol, the alcohol used for etherification being methyl alcohol, ethyl alcohol, n-propyl alcohol, i-propyl alcohol, n-butyl alcohol, i-butyl alcohol, 2-ethylbutanol or 2-ethylhexanol, for example.

The amino resin is most preferably a melamine resin, preferred among which are alkyl etherified melamine resins such as methyl etherified melamine resins wherein the methylol groups of a methylolated melamine resin have been partially or totally etherified with methyl alcohol, butyl etherified melamine resins in which they have been partially or totally etherified with butyl alcohol, and methyl-butyl mixed etherified melamine resins in which they have been partially or totally etherified with methyl alcohol and butyl alcohol.

Examples of blocked polyisocyanate compounds include those having the isocyanate groups of a polyisocyanate compound with at least two isocyanate groups in the molecule blocked with a blocking agent such as active methylene, oxime, phenol, alcohol, lactam, mercaptane or pyrazole. Examples of polyisocyanate compounds include aliphatic polyisocyanates, alicyclic polyisocyanates, aromatic aliphatic polyisocyanates, aromatic polyisocyanates and derivatives of these polyisocyanates.

The curing agent (C) may be used in the range of usually 5 to 60 parts by mass, preferably 10 to 50 parts by mass and more preferably 15 to 45 parts by mass, as the solid content based on 100 parts by mass as the solid resin content in the present coating material.

### Brilliant Pigment (D):

The brilliant pigment (D) is not particularly restricted so long as it is a brilliant pigment consisting of metal fragments obtained by pulverizing a vapor deposited metal film.

Such a brilliant pigment can usually be obtained by vapor depositing a metal film on a base film and separating off the base film, and then forming metal fragments by pulverizing the vapor deposited metal film. The thickness of the vapor deposited metal film during this time, i.e. the thickness of the metal fragments obtained by pulverizing, is typically preferred to be about 0.01 to 1 μm. At less than 0.01 μm, the color of the base layer will tend to penetrate, and at greater than 1 μm the metal fragments may cause diffuse reflection.

Because the brilliant pigment is a brilliant pigment consisting of metal fragments obtained by pulverizing a vapor deposited metal film, the metal fragments have extremely low thickness. The degree of pulverization of the metal fragments is typically preferred to be to a mean particle diameter (D50) of 1 to 50 μm and preferably 5 to 20 μm. The mean particle diameter is the median diameter (D50) of the volume-based particle size distribution measured by laser diffraction scattering, and it is the value measured using a MICROTRAC particle size distribution analyzer by Nikkiso Co., Ltd.

The material of the vapor deposited metal film is not particularly restricted, and it may be a metal film of aluminum, gold, silver, copper, chromium, nickel or the like. From the viewpoint of corrosion, it is particularly preferred to use aluminum fragments as the brilliant pigment. Aluminum fragments may also be subjected to appropriate surface treatment.

The pigment weight concentration (PWC) of the brilliant pigment (D) of the present coating material is preferably in the range of 10 to 40% and especially in the range of 10 to 35%, from the viewpoint of imparting a metallic gloss feel to the coating film that is formed.

### Aqueous Base Coat Coating Material:

The aqueous base coat coating material of the invention may contain another resin component as necessary in addition to the water-dispersible acrylic polymer particles (A), water-soluble acrylic resin (B), curing agent (C) and brilliant pigment (D).

The other resin component used may be a cellulose derivative (E), from the viewpoint of improving the metallic feel of the coating film that is to be obtained.

From the viewpoint of use in an aqueous coating material, the cellulose derivative (E) is preferably a carboxylated cellulose ester, examples of which include carboxymethyl cellulose acetate butyrate, carboxymethyl cellulose acetate, carboxymethyl cellulose butyrate and carboxymethyl cellulose propionate. These may be used alone or in combinations of two or more.

When the cellulose derivative (E) is used, the amount is preferably in the range of no greater than 40 parts by mass, preferably 5 to 30 parts by mass and more preferably 10 to 25 parts by mass, as the solid content based on 100 parts by mass as the solid resin content in the present coating material, from the viewpoint of sheen quality and water resistance.

The other resin component may be one that is commonly used in aqueous base coat coating materials, such as an acrylic resin, polyester resin, urethane resin or epoxy resin other than component (A) and component (B), among which the acrylic resins and polyester resins mentioned below are preferred. These resins may be used alone or in combinations of two or more.

The acrylic resin that may be added to the present coating material as necessary is not particularly restricted, and for example, it may be an acrylic resin obtained by copolymerization of a polymerizable unsaturated monomer by a solution polymerization method, using a common method. The organic solvent used for solution polymerization is preferably a propylene glycol-based or dipropylene glycol-based hydrophilic organic solvent, for example. From the viewpoint of water dispersibility, the acrylic resin preferably has an acidic group such as a carboxyl group.

There are no particular restrictions on the polymerizable unsaturated monomer, and it may be a polymerizable unsaturated monomer such as a carboxyl group-containing polymerizable unsaturated monomer (iii), hydroxyl-containing polymerizable unsaturated monomer (ii) or other polymerizable unsaturated monomer (iv) as mentioned above for the water-soluble acrylic resin (B), for example.

The acrylic resin preferably has a weight-average molecular weight in the range of usually 1,000 to 200,000 and especially 2,000 to 100,000. Preferably, the acrylic resin has a hydroxyl value in the range of usually 10 to 250 mgKOH/g and especially 30 to 150 mgKOH/g, and an acid value in the range of usually 10 to 100 mgKOH/g and especially 20 to 60 mgKOH/g.

The content of the acrylic resin may be in the range of usually 0 to 40 mass % and preferably 5 to 35 mass %, as the solid content based on the total solid resin content in the present coating material.

There are no particular restrictions on the polyester resin that may be added to the present coating material as necessary, and for example, it may be a polyester resin that can be synthesized by esterification reaction between a polybasic acid and a polyhydric alcohol using a common method.

The polybasic acid is a compound having two or more carboxyl groups in the molecule, and examples include phthalic acid, isophthalic acid, terephthalic acid, succinic acid, adipic acid, azelaic acid, sebacic acid, tetrahydrophthalic acid, hexahydrophthalic acid, chlorendic acid, maleic acid, fumaric acid, itaconic acid and trimellitic acid, and their anhydrides. The polyhydric alcohol is a compound having two or more hydroxyl groups in the molecule, and examples include ethylene glycol, propylene glycol, butylene glycol, hexanediol, diethylene glycol, dipropylene glycol, neopentyl glycol, triethylene glycol, glycerin, trimethylolethane, trimethylolpropane and pentaerythritol.

The polyester resin used may be a fatty acid-modified polyester resin obtained by modifying a polyester resin obtained as described above, with a (half) dry oil fatty acid such as linseed oil fatty acid, coconut oil fatty acid, safflower oil fatty acid, soybean oil fatty acid, sesame oil fatty acid, perilla oil fatty acid, hemp oil fatty acid, tall oil fatty acid or dehydrated castor oil fatty acid. The degree of modification by these fatty acids is generally preferred to be no greater than 30 mass % in terms of oil length. It may also be one that has been partially reacted with a monobasic acid such as benzoic acid. In order to introduce an acid group into the polyester resin, the esterification reaction of the polybasic acid and the polyhydric alcohol may be followed by reaction with a polybasic acid or its anhydride, such as trimellitic acid or trimellitic anhydride.

The polyester resin preferably has a weight-average molecular weight in the range of usually 1,000 to 200,000 and especially 2,000 to 50,000. Preferably, the polyester resin has a hydroxyl value in the range of usually 10 to 250 mgKOH/g and especially 30 to 150 mgKOH/g, and an acid value in the range of usually 10 to 100 mgKOH/g and especially 20 to 60 mgKOH/g.

The content of the polyester resin may be in the range of usually 0 to 40 mass % and preferably 5 to 35 mass %, as the solid content based on the total solid resin content in the present coating material.

The present coating material may also contain if necessary, in addition to the brilliant pigment (D), a pigment such as another brilliant pigment, or a color pigment or extender pigment.

The brilliant pigment-containing aqueous base coat coating material of the invention may also contain, if necessary, other coating material additives that are commonly used when preparing aqueous coating materials, such as ultraviolet absorbers, light stabilizers, surface control agents, polymer microparticles, basic neutralizing agents, antiseptic agents, rust-preventive agents, silane coupling agents, pigment dispersants, anti-settling agents, thickening agents, antifoaming agents, curing catalysts, antidegradants, anti-flow agents, water and organic solvents.

From the viewpoint of sheen quality of the coating film that is formed, the present coating material preferably has a coating material solid content in the range of usually 2 to 20 mass % and especially 2 to 15 mass %. The present coating material also preferably has a pH in the range of usually 7.5 to 9.0 and especially 7.5 to 8.5.

Throughout the present specification, the coating material solid content of the brilliant pigment-containing aqueous base coat coating material is the mass ratio of the nonvolatile component after the brilliant pigment-containing aqueous base coat coating material has been dried at 110° C. for 1 hour, and it can be determined by taking approximately 2 g of the brilliant pigment-containing aqueous base coat coating material in an aluminum foil cup with a diameter of approximately 5 cm, thoroughly spreading it over the entire bottom of the cup, and then drying it at 110° C. for 1 hour, and calculating from the coating material mass before drying and the coating material mass after drying.

### Article to be Coated:

There are no particular restrictions on articles to be coated by application of the present coating material, and examples include external platings of automobile bodies of passenger vehicles, trucks, motorcycles and buses; automobile parts; and external platings of consumer electric products such as cellular phones or audio devices, among which external platings of automobile bodies and automobile parts are preferred.

Base materials composing such articles to be coated are not particularly restricted, and examples include metal sheets such as iron sheets, aluminum sheets, brass sheets, copper sheets, stainless steel sheets, tin sheets, galvanized steel sheets and alloyed zinc (such as Zn—Al, Zn—Ni and Zn—Fe)-plated steel sheets; plastic materials including resins such as polyethylene resins, polypropylene resins, acrylonitrile-butadiene-styrene (ABS) resins, polyamide resins, acrylic resins, vinylidene chloride resins, polycarbonate resins, polyurethane resins and epoxy resins, or various FRP materials; inorganic materials such as glass, cement and concrete; wood materials; fiber materials (such as paper and fabrics), and the like, among which metal sheets and plastic materials are preferred.

The article to be coated may be one having an undercoat film or an undercoat film and intercoating film formed on a base material such as described above. When the base material is made of metal, it is preferably first subjected to chemical conversion treatment by phosphate treatment, chromate treatment, metal oxide treatment or the like, before forming the undercoat film.

The undercoat film is formed for the purpose of imparting corrosion resistance, rust resistance, adhesiveness with the base material, as well as a masking property for irregularities on the base material surface (also referred to as “base layer masking property”), and the primer coating to be used for formation of the undercoat film may be a known one, while it is preferred to use a cationic electrodeposition coating or anionic electrodeposition coating on a conductive base material such as metal, or a chlorinated polyolefin resin-based coating material on a low-polar base material such as polypropylene.

The primer coating may be cured by means such as heating or blasting after its application, or it may be dried to an extent that avoids curing. When a cationic electrodeposition coating or anionic electrodeposition coating is used as the primer coating, it is preferred to carry out heating after application of the primer coating to cure the undercoat film, in order to prevent layer mixing between the undercoat film and the coating film formed afterwards on the undercoat film, and to form a multilayer coating film with an excellent outer appearance.

Also, the intercoating film is formed on the undercoat film for the purpose of imparting adhesiveness with the undercoat film, a masking property for the undercoat film color (also referred to as “color masking property”), a masking property for irregularities on the undercoat film surface, and chipping resistance.

The intercoating film can be formed by coating an intercoat material, the film thickness of which is preferably in the range of usually 10 to 50 μm and especially 15 to 30 μm, as the cured film thickness.

The intercoat material used may be a known one, examples of which include intercoat materials that contain a base resin such as a hydroxyl-containing polyester resin or hydroxyl-containing acrylic resin as the vehicle component and a crosslinking agent such as a melamine resin or a blocked polyisocyanate.

The intercoat material is preferably cured or made tack free by means such as heating or blasting after its application, since this will help prevent layer mixing with the coating material that is subsequently applied onto the intercoating film, and will allow formation of a multilayer coating film with an excellent outer appearance.

### Coating Method:

The method of coating the present coating material on an article to be coated is not particularly restricted, and examples include methods such as air spray coating, airless spray coating and rotary atomizing coating, which are coating methods that allow formation of wet films on articles to be coated. These coating methods may if necessary involve electrostatic application, among which electrostatic coating with a rotary atomizing system or electrostatic coating with an air spray system are preferred, and electrostatic coating with a rotary atomizing system is particularly preferred.

In the case of air spray coating, airless spray coating or rotary atomizing coating, the viscosity of the present coating material is preferably adjusted as appropriate using water and/or an organic solvent to within a suitable viscosity range for coating, and usually to a viscosity range of about 15-60 seconds at 20° C. as measured with a Ford cup #4 viscometer.

Curing of the formed wet coating film may be accomplished by heating after application of the present coating material on an article to be coated. Heating may be carried out by known heating means, using a drying furnace such as an air heating furnace, electric furnace or infrared induction heating furnace, for example. A suitable heating temperature will usually be in the range of about 80° C. to about 180° C., and preferably about 100° C. to about 160° C. The heating time is not particularly restricted but will usually be about 10 to 40 minutes.

The film thickness of the present coating material is suitably in the range of usually 0.1 to 10 μm and preferably 0.1 to 7 μm, as the cured film thickness.

A multilayer coating film may be formed by a 2-coat, 1-bake system, wherein the present coating material is applied onto the article to be coated and a clear coating material is applied over it, without curing the formed coating film, after which the coating film of the present coating material and the clear coat coating film are simultaneously heat cured. When the coated surface is an uncured intercoating film surface, the system used may be a 3-coat, 1-bake system.

When the multilayer coating film is to be formed by a 2-coat, 1-bake system, preheating is preferably carried out after application of the present coating material, at a temperature at which the coating film substantially does not cure, from the viewpoint of preventing generation of coating defects such as cissing. The preheating temperature may usually be about 50 to 100° C., and the preheating time may be about 30 seconds to 10 minutes, and preferably about 1 to 5 minutes.

After the clear coating material has been applied onto the obtained uncured base coat coating film (the coating film of the present coating material) using a coating machine such as a rotary atomizing electrostatic coater, airless spray coater or air spray coater, it is heated at a temperature of usually about 100° C. to about 180° C. and preferably about 120° C. to about 160° C. for about 10 to 40 minutes, to simultaneously cure both coating films, thereby allowing a multilayer coating film with an excellent outer appearance to be formed.

Since the present coating material may be used to form a coating film with excellent film performance and sheen quality, the present coating material is suitable for use as a coating material for automobiles.

In a coating line for automobile bodies, usually application is carried out with division into zones using the same type of coating material, thereby minimizing reduction in coating quality caused by adhesion of flying coating material onto the article to be coated or the coating film, and for an automobile coating line, it is generally divided into an undercoat coating zone, intercoat coating zone, base coat coating zone and clear coat coating zone.

Moreover, within each coating zone, usually coating is divided into two or more stages, with setting (standing) for about 30 seconds to 3 minutes between each coating, in order to prevent dripping of the coating material and obtain high coated quality, with the coating within the same zone being referred to in chronological order of coating, i.e. first stage, second stage, . . . etc.

Such a coating method is generally referred to as multistage coating, and for example, when coating in the same zone is divided into 2 stages it is called “two-stage coating”, and when it is divided into 3 stages it is called “three-stage coating”. When application of an aqueous base coat coating material is carried out in the base coat coating zone, it is preferably by two-stage coating from the viewpoint of outer appearance of the coating film and coating efficiency.

When application of the aqueous base coat coating material is carried out by two-stage coating, the aqueous base coat coating material applied in the first stage and the aqueous base coat coating material applied in the second stage may be the same or different. By using different aqueous base coat coating materials in the first stage and second stage, and applying an aqueous base coat coating material (X1) having a coating material solid content of 8 to 40 mass % in the first stage and applying an aqueous base coat coating material (X2) of the invention adjusted to a coating material solid content of 2 to 5 mass % and especially 2 to 4 mass %, in the second stage, it is possible to form a coating film having excellent sheen quality and film performance (hereunder, this coating method will be referred to as “double base coat application method”).

The period from completion of application in the first stage until the start of application in the second stage during the double base coat application method described above is preferably an interval of about 30 seconds to 3 minutes without preheating, from the viewpoint of energy savings and improved productivity.

There are no particular restrictions on the aqueous base coat coating material (X1) used, which may be a known aqueous base coat coating material, and for example, an aqueous base coat coating material (X1-1) of the invention adjusted to a coating material solid content in the range of 8 to 20 mass %, or an aqueous base coat coating material (X1-2) with a PWC of less than 15% of brilliant pigments other than the brilliant pigment (D) and adjusted to a coating material solid content in the range of 15 to 40 mass %, may be used.

Preferably, the dry film thickness (T1-1) of the aqueous base coat coating material (X1-1) is in the range of 2 to 5 μm and especially 2 to 4 μm, the dry film thickness (T1-2) of the aqueous base coat coating material (X1-2) is in the range of 5 to 15 μm and especially 7 to 14 μm, and the dry film thickness (T2) of the aqueous base coat coating material (X2) is in the range of usually 0.1 to 1 μm and especially 0.1 to 0.5 μm.

When the clear coating material is to be applied onto a base coating film formed by the double base coat application method described above, it is preferred to carry out preheating at a temperature at which the coating film substantially does not cure, after application of the aqueous base coat coating material in the second stage, from the viewpoint of preventing generation of coating defects such as cissing. The preheating temperature may usually be in the range of about 50° C. to about 100° C., and the preheating time may usually be about 30 seconds to 10 minutes, and preferably about 1 to 5 minutes.

After the clear coating material has been applied onto the uncured brilliant pigment-containing base coating film obtained by carrying out the aforementioned preheating, using a coating machine such as a rotary atomizing electrostatic coater, airless spray coater or air spray coater, it is heated at a temperature of usually about 100° C. to about 180° C. and preferably about 120° C. to about 160° C. for about 10 to 40 minutes, to simultaneously cure both coating films, thereby allowing a multilayer coating film with an excellent outer appearance (sheen quality, smoothness, etc.) to be formed.

### Clear Coating Material:

The clear coating material used may be a known one that is commonly used for coating of automobile bodies, and specific examples include organic solvent-based thermosetting coating materials, aqueous thermosetting coating materials and thermosetting powder coating materials comprising, as vehicle components, base resins such as acrylic resins, polyester resins, alkyd resins, urethane resins, epoxy resins and fluorine resins, that have crosslinkable functional groups such as hydroxyl, carboxyl groups, epoxy groups or silanol groups, and crosslinking agents such as melamine resins, urea resins, polyisocyanate compounds which may be blocked, carboxyl group-containing compounds or resins and epoxy group-containing compounds or resins. The clear coating material may also be a one-pack type coating material, or a two-pack coating material such as a two-pack urethane resin coating material.

According to the invention, the clear coating material is most preferably one containing a hydroxyl-containing acrylic resin and a polyisocyanate compound.

The hydroxyl-containing acrylic resin may be produced by copolymerization of a hydroxyl-containing polymerizable unsaturated monomer and another polymerizable unsaturated monomer that is copolymerizable with the monomer, by a common method. The hydroxyl-containing polymerizable unsaturated monomer and the other polymerizable unsaturated monomer that is copolymerizable with the monomer may be appropriately selected from among the hydroxyl-containing polymerizable unsaturated monomer (ii), carboxyl group-containing polymerizable unsaturated monomer (iii) and other polymerizable unsaturated monomer (iv), mentioned above in the explanation of the water-soluble acrylic resin (B).

The polyisocyanate compound is a compound having at least two isocyanate groups in the molecule, and examples include aliphatic polyisocyanates, alicyclic polyisocyanates, aromatic aliphatic polyisocyanates, aromatic polyisocyanates, and derivatives of these polyisocyanates, any of which may be used alone or in combinations of two or more. Among these polyisocyanate compounds, it is preferred to use aliphatic diisocyanates and aliphatic diisocyanate derivatives, from the viewpoint of smoothness, sharpness and weather resistance of the coating film that is to be obtained.

The equivalent ratio of hydroxyl groups of the hydroxyl-containing acrylic resin and isocyanate groups of the polyisocyanate compound (NCO/OH) is suitable in the range of preferably 0.5 to 2.0 and more preferably 0.8 to 1.5.

Also, the clear coating material may contain, as necessary, color pigments, brilliant pigments, dyes and the like in ranges that do not impair the transparency, and may further contain, as suitable, nonaqueous dispersion resins, extender pigments, curing catalysts, ultraviolet absorbers, light stabilizers, antifoaming agents, thickening agents, rust-preventive agents, surface control agents and the like.

The film thickness of the clear coat coating film is preferably in the range of usually 15 to 60 μm and especially 20 to 50 μm, as the dry film thickness, from the viewpoint of the outer appearance of the coating film and coating manageability.

### EXAMPLES

The present invention will now be explained in greater detail using examples and comparative examples. However, it is to be understood that the invention is not limited only to these examples. The “parts” and “%” values are all based on mass.

### Production Example of Water-Dispersible Acrylic Polymer Particles (A)

### Production Example 1

After charging 100 parts of deionized water and 0.5 part of AQUALON KH-10 (see note 1) into a reactor equipped with a thermometer, thermostat, stirrer, reflux condenser, nitrogen inlet tube and dropper, the mixture was stirred in a nitrogen stream and the temperature was increased to 80° C. Next, 1% of the total monomer emulsion (1) described below and 10.3 parts of a 3% ammonium persulfate aqueous solution were introduced into the reactor, and the mixture was kept at 80° C. for 15 minutes. The remainder of the monomer emulsion (1) was then added dropwise into the reactor over a period of 3 hours, and upon completion of the dropwise addition the mixture was aged for 1 hour. Next, the monomer emulsion (2) described below was added dropwise over a period of 2 hours and aged for 1 hour, and then cooled to 30° C. while gradually adding 42 parts of a 5% 2-(dimethylamino)ethanol aqueous solution to the reactor and discharged while filtering with a 100 mesh nylon cloth, to obtain an aqueous dispersion of a water-dispersible acrylic polymer particle (A1) having a mean particle diameter of 100 nm (measured at 20° C. using a “COULTER N4” submicron particle size distribution analyzer (trade name of Beckman Coulter, Inc.) after dilution with deionized water), an acid value of 33 mgKOH/g, a hydroxyl value of 48 mgKOH/g and a solid content of 30%.

(Note 1): AQUALON KH-10: Ammonium salt of polyoxyethylenealkyl ether sulfate, trade name of Dai-ichi Kogyo Seiyaku Co., Ltd., active ingredient: 97%.

Monomer emulsion (1): 60 parts deionized water, 1 part AQUALON KH-10, 3 parts methylenebisacrylamide, 4 parts styrene, 13 parts methyl methacrylate, 30 parts ethyl acrylate and 20 parts n-butyl acrylate were mixed and stirred to obtain monomer emulsion (1).

Monomer emulsion (2): 20 parts deionized water, 1 part AQUALON KH-10, 0.1 part ammonium persulfate, 3 parts styrene, 6 parts methyl methacrylate, 2 parts ethyl acrylate, 4 parts n-butyl acrylate, 10 parts 2-hydroxyethyl acrylate and 5 parts methacrylic acid were mixed and stirred to obtain monomer emulsion (2).

### Production Examples 2 to 7

The same procedure was carried out as in Production Example 1, except for using the components in the mixing proportions shown in Table 1, to obtain water-dispersible acrylic polymer particles (A2) to (A7). The solid concentrations, acid values and hydroxyl values of water-dispersible acrylic polymer particles (A1) to (A7) are shown in Table 1 together with those of the water-dispersible acrylic polymer particles (A1) obtained in Production Example 1.

TABLE 1

| Production Example | | 1 | 2 | 3 | 4 | 5 | 6 | 7 |
|---|---|---|---|---|---|---|---|---|
| Water-dispersible acrylic polymer particle | | A1 | A2 | A3 | A4 | A5 | A6 | A7 |
| Deionized water | | 100 | | | | | | |
| AQUALON KH-10 (Note 1) | | 0.5 | 0.5 | | 0.5 | 0.5 | 0.5 | 0.5 |
| Newcol 562SN (Note 2) | | | | 1.7 | | | | |
| Deionized water | | 10 | | | | | | |
| Ammonium persulfate | | 0.3 | | | | | | |
| Monomer | Deionized water | 60 | 70 | 60 | 60 | 60 | 60 | 60 |
| emulsion 1 | AQUALON KH-10 (Note 1) | 1 | 1 | | 1 | 1 | 1 | 1 |
| | Newcol 562SN (Note 2) | | | 3 | | | | |
| | Methylenebisacrylamide | 3 | 3 | 3 | 3 | 3 | 3 | 1 |
| | 1,6-Hexanediol diacrylate | | | | | | | 2 |
| | Methacrylic acid | | 2 | | | | | |
| | Hydroxyethyl acrylate | | 5 | | | | | |
| | Styrene | 4 | 4 | 4 | 4 | 4 | 4 | 5 |
| | Methyl methacrylate | 13 | 12 | 13 | 13 | 13 | 13 | 15 |
| | Ethyl acrylate | 30 | 34 | 10 | 30 | 30 | 30 | 10 |
| | n-Butyl acrylate | 20 | 20 | 40 | 20 | 20 | 20 | 37 |
| Monomer | Deionized water | 20 | 10 | 20 | 20 | 20 | 20 | 20 |
| emulsion 2 | AQUALON KH-10 (Note 1) | 1 | 1 | | 0.5 | 0.5 | 0.5 | 1 |
| | Newcol 562SN (Note 2) | | | 3 | | | | |
| | Ammonium persulfate | 0.1 | | | | | | |
| | Methacrylic acid | 5 | 5 | 5 | 5 | | 5 | 5 |
| | Acrylic acid | | | | | 5 | | |
| | Hydroxyethyl acrylate | 10 | 8 | 10 | 3 | 3 | 3 | 10 |
| | Styrene | 3 | 3 | 3 | 3 | 3 | | 3 |
| | Methyl methacrylate | 6 | | 6 | 6 | 6 | 6 | 6 |
| | Ethyl acrylate | 2 | 2 | 2 | 2 | 2 | 2 | 2 |
| | n-Butyl acrylate | 4 | 2 | 4 | 11 | 11 | 14 | 4 |

| 5% Dimethylethanolamine aqueous solution | 42 | | | | | | |
|---|---|---|---|---|---|---|---|
| Solid content concentration (mass %) | 30 | | | | | | |
| Acid value (mgKOH/g) | 33 | 46 | 33 | 33 | 39 | 33 | 33 |
| Hydroxyl value(mgKOH/g) | 48 | 63 | 48 | 15 | 15 | 15 | 48 |

### Production Example for Water-Soluble Acrylic Resin (B)

### Production Example 8

After charging 90 parts of propyleneglycol monopropyl ether into a 4-necked glass flask equipped with a thermometer, stirrer, condenser tube and water separator, the temperature was raised to 90° C. while stirring, and then a mixture of 19.7 parts of n-butyl acrylate, 15 parts of methyl methacrylate, 30 parts of styrene, 20 parts of N-butoxymethylacrylamide, 12 parts of 2-hydroxylethyl methacrylate, 3.3 parts of acrylic acid and 1 part of azobisisobutyronitrile was added dropwise at a constant rate over a period of 4 hours using a dropping pump, while maintaining a temperature of 90° C. Upon completion of the dropwise addition, stirring was continued for another hour at 90° C. Next, a solution of 0.5 part of azobisisobutyronitrile dissolved in 10 parts of propyleneglycol monopropyl ether was added dropwise at a constant rate over a period of 1 hour, and the temperature was kept at 90° C. for 1 hour to obtain acrylic resin solution (B1) having a solid content of 50%. The obtained acrylic resin had an acid value of 25 mgKOH/g, a hydroxyl value of 50 mgKOH/g and a weight-average molecular weight of 45,000.

### Production Examples 9 to 17

The same procedure was carried out as in Production Example 8, except for using the monomer components in the mixing proportions listed in Table 2, to obtain acryl resins (B2) to (B10). The solid concentrations, weight-average molecular weights, acid values and hydroxyl values of the obtained acrylic resins (B1) to (B10) are shown in Table 2, together with those of the acrylic resin (B1) obtained in Production Example 8.

TABLE 2

| Production Example No. | 8 | 9 | 10 | 11 | 12 | 13 | 14 | 15 | 16 | 17 |
|---|---|---|---|---|---|---|---|---|---|---|
| Acrylic resin | B1 | B2 | B3 | B4 | B5 | B6 | B7 | B8 | B9 | B10 |
| Styrene | 30 | 30 | 30 | 30 | 30 | 30 | 30 | 30 | 30 | 30 |
| Methyl methacrylate | 15 | 35 | | | | | | 15 | 15 | 15 |
| Ethyl acrylate | | | | 25.3 | | 19.9 | 34.2 | 20 | 12 | 6.3 |
| N-Butyl acrylate | 19.7 | | | | 13.6 | | | 19.7 | 19.7 | 16.7 |
| 2-Ethylhexyl acrylate | | | 26.6 | | | | | | | |
| N-Butoxymethylacrylamide | 20 | | | 20 | 40 | 30 | 20 | | 20 | 20 |
| N-Methoxymethylacrylamide | | 20 | | | | | | | | |
| N-Methylolacrylamide | | | 20 | | | | | | | |
| 2-Hydroxyethyl methacrylate | 12 | 12 | 12 | | | | | 12 | | 12 |
| 2-Hydroxyethyl acrylate | | | | 21.4 | 10.7 | 17.1 | 10.7 | | | |
| Acrylic acid | 3.3 | | | 3.3 | | | | 3.3 | 3.3 | |
| Itaconic acid | | 3 | 11.4 | | 5.7 | 3 | | | | |
| Maleic acid | | | | | | | 5.1 | | | |
| Weight-average molecular | 45,000 | 45,000 | 60,000 | 45,000 | 50,000 | 45,000 | 45,000 | 45,000 | 45,000 | 40,000 |
| weight | | | | | | | | | | |
| Hydroxyl value (mgKOH/g) | 50 | 50 | 50 | 100 | 50 | 80 | 50 | 50 | 0 | 50 |
| Acid value (mgKOH/g) | 25 | 25 | 100 | 25 | 50 | 25 | 50 | 25 | 25 | 0 |
| Solid content concentration (%) | 50 | 50 | 50 | 50 | 50 | 50 | 50 | 50 | 50 | 50 |

### Preparation of Cellulose Derivative Aqueous Solution

### Production Example 18

Carboxymethyl cellulose acetate butyrate (“Solus3050”, trade name of Eastman Chemical Company, acid value: 50 mgKOH/g), water, octanol and dimethylethanolamine were used to obtain a cellulose derivative aqueous solution (E1) having a solid content of 20% and a pH of 7.

### Production Example for Polyester Resin

### Production Example 19

After charging 109 parts of trimethylolpropane, 142 parts of 1,6-hexanediol, 126 parts of hexahydrophthalic anhydride and 120 parts of adipic acid into a reactor equipped with a stirrer, reflux condenser, water separator and thermometer, the temperature was raised to between 160° C. and 230° C. over a period of 3 hours, and condensation reaction was conducted at 230° C. for 4 hours. Next, 46 parts of trimellitic anhydride was further added for addition of carboxyl groups to the obtained condensation reaction product, and reaction was conducted at 180° C. for 1 hour, after which the mixture was diluted with octanol to obtain polyester resin (F1) having an acid value of 49 mgKOH/g, a hydroxyl value of 140 mgKOH/g, a solid content of 70% and a weight-average molecular weight of 6,400.

### Fabrication of Aqueous Base Coat Coating Material

### Example 1

Vapor deposited aluminum flake paste (“Hydroshine WS-3004” product of Eckart Co., solid content: 10%, interior solvent: isopropanol, mean particle diameter D50: 13 μm, thickness: 0.05 μm, silica-treated surface) was loaded into a stirring/mixing vessel to a solid content of 30 parts, and while stirring, there were added and mixed the cellulose derivative aqueous solution (E1) obtained in Production Example 18 to a solid content of 20 parts, “CYMEL 251” (trade name of Nihon Cytec Industries Inc., melamine resin, solid content: 80%) to a solid content of 25 parts, the acrylic resin (B4) solution obtained in Production Example 11 to a solid content of 20 parts, the polyester resin (F1) obtained in Production Example 19 to a solid content of 15 parts, and the water-dispersible acrylic polymer particle (A1) obtained in Production Example 1 to a solid content of 20 parts. To the obtained mixture there were appropriately added “PRIMAL ASE-60” (trade name of Rohm & Haas, polyacrylic acid-based thickening agent), 2-(dimethylamino)ethanol and deionized water, to obtain an aqueous base coat coating material (1) having a pH of 8.0 and a coating material solid content of 10%.

### Examples 2 to 19 and Comparative Examples 1 to 5

The same procedure was used as in Example 1, except for using each of the components of the mixing compositions shown in Table 3, to obtain aqueous base coat coating materials (2) to (24), each having a coating material solid content of 10% and a pH of 8.0. The formulations of each of the aqueous base coat coating materials of Table 3 are solid content formulations.

TABLE 3

| | | Example | | | | | | | | | | | | | | | | | | | Comp. Example | | | | |
|---|---|---|---|---|---|---|---|---|---|---|---|---|---|---|---|---|---|---|---|---|---|---|---|---|---|
| | | 1 | 2 | 3 | 4 | 5 | 6 | 7 | 8 | 9 | 10 | 11 | 12 | 13 | 14 | 15 | 16 | 17 | 18 | 19 | 1 | 2 | 3 | 4 | 5 |
| Aqueous base coat coating material | | 1 | 2 | 3 | 4 | 5 | 6 | 7 | 8 | 9 | 10 | 11 | 12 | 13 | 14 | 15 | 16 | 17 | 18 | 19 | 20 | 21 | 22 | 23 | 24 |
| No. | | | | | | | | | | | | | | | | | | | | | | | | | |
| Water-dispersible acrylic | A1 | 20 | | | | | | | 20 | 20 | 20 | 20 | 20 | 30 | 15 | 15 | 20 | 40 | 20 | 20 | 20 | 40 | 20 | 40 | 20 |
| polymer particles (A) | A2 | | 20 | | | | | | | | | | | | | | | | | | | | | | |
| | A3 | | | 20 | | | | | | | | | | | | | | | | | | | | | |
| | A4 | | | | 20 | | | | | | | | | | | | | | | | | | | | |
| | A5 | | | | | 20 | | | | | | | | | | | | | | | | | | | |
| | A6 | | | | | | 20 | | | | | | | | | | | | | | | | | | |
| | A7 | | | | | | | 20 | | | | | | | | | | | | | | | | | |
| Water-soluble acrylic resin | B1 | | | | | | | | 20 | | | | | | | | | | | | | | | | |
| (B) | B2 | | | | | | | | | 20 | | | | | | | | | | | | | | | |
| | B3 | | | | | | | | | | 20 | | | | | | | | | | | | | | |
| | B4 | 20 | 20 | 20 | 20 | 20 | 20 | 20 | | | | | | | | | | | | | | | | | |
| | B5 | | | | | | | | | | | 20 | | | | | | | | | | | | | |
| | B6 | | | | | | | | | | | | 20 | 20 | 20 | 15 | 20 | 20 | 20 | | | | | | |
| | B7 | | | | | | | | | | | | | | | | | | | 20 | | | | | |
| | B8 | | | | | | | | | | | | | | | | | | | | 20 | 20 | | | |
| | B9 | | | | | | | | | | | | | | | | | | | | | | 20 | 20 | |
| | B10 | | | | | | | | | | | | | | | | | | | | | | | | 20 |

| | | | | | | | | | | | | | | | | | | | | | | | | |
|---|---|---|---|---|---|---|---|---|---|---|---|---|---|---|---|---|---|---|---|---|---|---|---|---|
| Vapor deposited aluminum flake | 30 | 30 | 30 | 30 | 30 | 30 | 30 | 30 | 30 | 30 | 30 | 30 | 30 | 30 | 30 | 35 | 30 | 20 | 30 | 30 | 30 | 30 | 30 | 30 |
| paste | | | | | | | | | | | | | | | | | | | | | | | | |
| Melamine resin CYMEL 251 | 25 | 25 | 25 | 25 | 25 | 25 | 25 | 25 | 25 | 25 | 25 | 25 | 25 | 25 | 25 | 25 | 25 | 25 | 25 | 25 | 25 | 25 | 25 | 25 |
| Cellulose derivative aqueous | 20 | 20 | 20 | 20 | 20 | 20 | 20 | 20 | 20 | 20 | 20 | 20 | 10 | 30 | 40 | 20 | 0 | 20 | 20 | 20 | 0 | 20 | 0 | 20 |
| solution (E1) | | | | | | | | | | | | | | | | | | | | | | | | |
| Polyester resin (F1) | 15 | 15 | 15 | 15 | 15 | 15 | 15 | 15 | 15 | 15 | 15 | 15 | 15 | 10 | 5 | 15 | 15 | 15 | 15 | 15 | 15 | 15 | 15 | 15 |

### Example 20

Vapor deposited aluminum flake paste (“Hydroshine WS-3004” product of Eckart Co., solid content: 10%, interior solvent: isopropanol, mean particle diameter D50: 13 μm, thickness: 0.05 μm, silica-treated surface) was loaded into a stirring/mixing vessel to a solid content of 50 parts, and while stirring, there were added and mixed the cellulose derivative aqueous solution (E1) obtained in Production Example 18 to a solid content of 20 parts, “CYMEL 251” (trade name of Nihon Cytec Industries Inc., melamine resin, solid content: 80%) to a solid content of 25 parts, the acrylic resin (B4) solution obtained in Production Example 11 to a solid content of 20 parts, the polyester resin (F1) obtained in Production Example 19 to a solid content of 15 parts, and the water-dispersible acrylic polymer particle (A1) obtained in Production Example 1 to a solid content of 20 parts. To the obtained mixture there were added “PRIMAL ASE-60” (trade name of Rohm & Haas, polyacrylic acid-based thickening agent), 2-(dimethylamino)ethanol and deionized water, to obtain an aqueous base coat coating material (25) having a pH of 8.0 and a coating material solid content of 2.5%.

### Example 21

The same procedure was used as in Example 20, except that for Example 20, the acrylic resin (B6) obtained in Production Example 13 was used in the same amount instead of the acrylic resin (B4), to obtain an aqueous base coat coating material (26) having a pH of 8.0 and a coating material solid content of 2.5%.

### Fabrication of Test Article to be Coated I:

A zinc phosphate-treated cold-rolled steel sheet with 45 cm length×30 cm width×0.8 mm thickness was electrodeposited with “ELECRON GT-10” (trade name of Kansai Paint Co., Ltd., thermosetting epoxy resin-based cationic electrodeposition coating) to a dry film thickness of 20 μm, and heated at 170° C. for 30 minutes for curing to produce “test article to be coated I”.

### Fabrication of Test Sheet I

### Example 22

The test article to be coated I was electrostatically coated with “WP-522H N-2.0” (trade name of Kansai Paint Co., Ltd., polyester resin-based aqueous intercoat material, L* value of obtained coating film: 20) using a rotary atomizing bell coating machine, to a dry film thickness of 20 μm, and after standing for 3 minutes, it was preheated at 80° C. for 3 minutes, and the aqueous base coat coating material (1) obtained in Example 1 was electrostatically coated over it to a dry film thickness of 1.5 μm using an “ABB Cartridge Bell Coating Machine” (trade name of (ABB Co.) as a rotary atomizing bell coating machine, and was allowed to stand for 2 minutes and then preheated at 80° C. for 5 minutes. Next, the uncured base coat surface was coated with “KINO6510” (trade name of Kansai Paint Co., Ltd., hydroxyl/isocyanate group curable acrylurethane resin-based two-pack organic solvent coating material) to a dry film thickness of 30 μm, and after standing for 7 minutes, it was heated at 140° C. for 30 minutes, and both coating films were simultaneously cured to fabricate test sheet I.

### Examples 23 to 40, Comparative Examples 6 to 10

The same procedure was carried out as in Example 22, except for changing the aqueous base coat coating material (1) of Example 22 to the aqueous base coat coating materials listed in Table 4, to fabricate test sheets I for Examples 23 to 40 and Comparative Examples 6 to 10. Each of the test sheets I were evaluated by the following test methods. The results are shown in Table 4.

### (Test Methods)

Flip-flop property: Each test sheet was measured using a MA-68 Multi-Angle Spectrocolorimeter (trade name of X-Rite), determining the L value (brightness) at an acceptance angle of 15° and an acceptance angle of 110°, and calculating the FF value by the following formula.

FF value=L value at acceptance angle of 15°/L value at acceptance angle of 110°

A larger FF value indicates greater variation in the L value (brightness) depending on the observation angle (acceptance angle), and a more excellent flip-flop property.

Sheen quality: Each test sheet was visually examined at different angles, and the sheen quality was evaluated on the following scale.

VG: Very large change in metallic quality depending on visual angle, excellent flip-flop property, satisfactory sheen quality

G: Large change in metallic quality depending on visual angle, excellent flip-flop property, satisfactory sheen quality

F: Slightly low change in metallic quality depending on visual angle, slightly inferior flip-flop property, slightly inferior sheen quality

P: Low change in metallic quality depending on visual angle, inferior flip-flop property, inferior sheen quality

Smoothness: The outer appearance of the test sheet was visually evaluated.

VG: Very excellent smoothness

G: Excellent smoothness

F: Slightly inferior smoothness

P: Inferior smoothness

Initial adhesion: Notches were formed on the multilayer coating film of each test sheet up to the base using a cutter, to produce a square grid with 100 squares of size 2 mm×2 mm, adhesive tape was attached to the surface, and the number of squares left on the square grid coating film after rapidly peeling off the tape at 20° C. was determined.

VG: 100 squares remaining, with smooth edges of the cutter notches

G: 100 squares remaining, but minute peeling of the coating film occurred at the intersections of the cutter notches

F: 99 to 81 squares remaining

P: 80 squares remaining

Waterproof adhesiveness: Each test sheet was immersed in 80° C. warm water for 1 day, raised out and dried at room temperature for 12 hours, and then subjected to a square grid test in the same manner as the initial adhesion test. The evaluation scale was also the same as for the initial adhesion test.

TABLE 4

| | Example | | | | | | | | | | | |
|---|---|---|---|---|---|---|---|---|---|---|---|---|
| | 22 | 23 | 24 | 25 | 26 | 27 | 28 | 29 | 30 | 31 | 32 | 33 |
| Aqueous base coat coating material | 1 | 2 | 3 | 4 | 5 | 6 | 7 | 8 | 9 | 10 | 11 | 12 |
| No. | | | | | | | | | | | | |
| Dry film thickness (μm) | 1.5 | 1.5 | 1.5 | 1.5 | 1.5 | 1.5 | 1.5 | 1.5 | 1.5 | 1.5 | 1.5 | 1.5 |
| FF feel | 7.6 | 7.5 | 7.6 | 7.5 | 7.6 | 7.5 | 7.6 | 7.5 | 7.5 | 7.6 | 7.5 | 7.6 |
| Sheen quality | G | G | G | G | G | G | G | G | G | G | G | G |
| Smoothness | VG | VG | VG | VG | VG | VG | VG | VG | VG | VG | VG | VG |
| Early adhesion | VG | VG | VG | VG | VG | VG | VG | VG | VG | VG | VG | VG |
| Waterproof adhesiveness | VG | VG | VG | VG | VG | VG | VG | VG | VG | VG | VG | VG |
| | Example | | | | | | | Comp. Example | | | | |
| | 34 | 35 | 36 | 37 | 38 | 39 | 40 | 6 | 7 | 8 | 9 | 10 |
| Aqueous base coat coating material | 13 | 14 | 15 | 16 | 17 | 18 | 19 | 20 | 21 | 22 | 23 | 24 |
| No. | | | | | | | | | | | | |
| Dry film thickness (μm) | 1.5 | 1.5 | 1.5 | 1.5 | 1.5 | 1.5 | 1.5 | 1.5 | 1.5 | 1.5 | 1.5 | 1.5 |
| FF feel | 7.3 | 7.8 | 8 | 7.6 | 6.9 | 7.6 | 7.6 | 7.4 | 6.7 | 7.4 | 6.7 | 7.4 |
| Sheen quality | G | VG | VG | G | F | G | G | G | F | G | F | G |
| Smoothness | VG | VG | VG | VG | VG | VG | VG | VG | VG | VG | VG | VG |
| Early adhesion | VG | VG | VG | VG | VG | VG | VG | VG | VG | VG | VG | VG |
| Waterproof adhesiveness | VG | G | G | G | VG | VG | F | P | F | P | F | P |

### Fabrication of Test Article to be Coated II:

A zinc phosphate-treated cold-rolled steel sheet with 45 cm length×30 cm width×0.8 mm thickness was electrodeposited with “ELECRON GT-10” (trade name of Kansai Paint Co., Ltd., thermosetting epoxy resin-based cationic electrodeposition coating) to a dry film thickness of 20 μm, and heated at 170° C. for 30 minutes for curing, after which the intercoat material “AMILAC TP-65-2” (trade name of Kansai Paint Co., Ltd., polyester resin/amino resin-based, organic solvent-type intercoat material) was applied over it to a dry film thickness of 40 μm and heated at 140° C. for 30 minutes for curing, to produce “test article to be coated II”.

### Fabrication of Test Sheet II

### Example 41

The test article to be coated II was electrostatically coated with the aqueous base coat coating material (17) obtained in Example 17 to a dry film thickness of 4 μm using the rotary atomizing bell coating machine, “ABB Cartridge Bell Coating Machine” (trade name of ABB Co.), to form a first base coating film. After an interval of 1 minute, the aqueous base coat coating material (25) obtained in Example 20 was applied onto the first base coating film to a dry film thickness of 0.2 μm, to form a second base coating film. After an interval of 2 minutes, it was preheated at 80° C. for 3 minutes to form an uncured base coat coating film, which was then coated with “KINO6510” (trade name of Kansai Paint Co., Ltd., hydroxyl/isocyanate group curable acrylurethane resin-based two-pack organic solvent coating material) to a dry film thickness of 30 μm, and after standing for 7 minutes, it was heated at 140° C. for 30 minutes, and the coating films were simultaneously cured to fabricate test sheet II.

### Examples 42 to 46

The same procedure was carried out as in Example 41, except for changing each aqueous base coat coating material of Example 41 to the aqueous base coat coating materials listed in Table 5, to fabricate test sheets II for Examples 42 to 46. Each of the test sheets II were evaluated by the test methods described above. The results are shown in Table 5.

TABLE 5

| | Example | | | | | |
|---|---|---|---|---|---|---|
| | 41 | 42 | 43 | 44 | 45 | 46 |
| Aqueous base coat coating | 17 | 17 | 12 | 12 | 21 | 21 |
| material No. | | | | | | |
| Dry film thickness (μm) | 4 | 4 | 4 | 4 | 4 | 4 |
| Aqueous base coat coating | 25 | 26 | 25 | 26 | 25 | 26 |
| material No. | | | | | | |
| Dry film thickness (μm) | 0.2 | 0.2 | 0.2 | 0.2 | 0.2 | 0.2 |
| FF feel | 7.8 | 7.8 | 7.9 | 7.9 | 7.3 | 7.3 |
| Sheen quality | VG | VG | VG | VG | G | G |
| Smoothness | VG | VG | VG | VG | VG | VG |
| Early adhesion | VG | VG | VG | VG | VG | VG |
| Waterproof adhesiveness | VG | VG | VG | VG | F | F |

1-5. (canceled)

6. A method for coating an aqueous base coat coating material, comprising:
applying an aqueous base coat coating material (X1) having a coating material solid content in the range of 8 to 40 mass % onto an article to be coated to form a first base coating film, and a step of applying an aqueous base coat coating material (X2) having a coating material solid content in the range of 2 to 5 mass % onto the uncured first base coating film formed in the previous step, to form a second base coating film, carried out in that order,
wherein the aqueous base coat coating material (X2) is an aqueous base coat coating material according to any one of claims 1 to 3.

7. A method for forming a multilayer film, wherein a clear coating material is applied onto an uncured base coat coating film obtained by the method for coating an aqueous base coat coating material according to claim 6, to form a clear coat coating film, and then the base coating film and the clear coat coating film are simultaneously heat cured.

8. The method for forming a multilayer film according to claim 7, wherein the clear coating material contains a hydroxyl-containing acrylic resin and a polyisocyanate compound.
